(19) United States
(12) Patent Application Publication
(10) Pub. No.: US 2007/0185689 A1
(43) Pub. Date: Aug. 9, 2007

(54) Systems and methods for event detection and logging in access control points

(75) Inventors: Frank Steve Muraski, Brown Summitt, NC (US); Adam Irving JR., Greensboro, NC (US)

Correspondence Address: KILPATRICK STOCKTON LLP, 1001 WEST FOURTH STREET, WINSTON-SALEM, NC, 27101, US

(73) Assignee: Sigcom, Inc.

(21) Appl. No.: 11/348,722

(22) Filed: Feb. 7, 2006

(51) Int. Cl. G06F 17/40; G06F 11/00; G06F 1/00; G08B 29/00

(52) U.S. Cl. 702/187; 713/500; 714/57; 340/506

(57) ABSTRACT

Systems and methods for event detection and logging in access control points are described. One described method includes detecting an event; transmitting a timing correction request over a communications link; receiving a first timing signal having a first send time; and transmitting a second timing signal. The timing signal has a second send time, a first receive time associated with the first send time, and the first send time. The method further includes receiving a timing correction based at least in part on a reference time and a latency of the communications link; determining a corrected timestamp using the timing correction; and recording the event and the corrected timestamp.

### FIELD OF THE INVENTION

This invention generally relates to access control points. This invention more particularly relates to systems and methods for event detection and logging in access control points.

### BACKGROUND

An access control point (ACP) is a system that is implemented to control access to an area that is restricted to only certain, authorized personnel. An ACP may be configured in any of a number of ways to meet the security and event logging needs of the area to be restricted. Certain varieties of ACPs are frequently used in office buildings to restrict access by the public or personnel not authorized to access the office building or portions of the office building.

For example, an ACP may include a guard stand, a sensor for detecting an access request, and a door that can be opened by the guard on duty. In such an ACP, the sensor might alert the guard on duty of the presence of an individual requesting access to the restricted area. The guard may then request proof of authorization and, if such authorization is provided, open the door, or deny access if such authorization is not provided. The guard may then make an entry into a logbook with the time of attempted access, whether access was granted or denied, and other information.

### SUMMARY

The present invention provides systems and methods for event detection and logging in access control points. One embodiment of the present invention provides a method for event recording comprising detecting an event; transmitting a timing correction request over a communications link; receiving a first timing signal having a first send time; and transmitting a second timing signal. The timing signal has a second send time, a first receive time associated with the first send time, and the first send time. The method further comprises receiving a timing correction based at least in part on a reference time and a latency of the communications link; determining a corrected timestamp using the timing correction; and recording the event and the corrected timestamp. In another embodiment a computer-readable media comprises code for a carrying out such a method.

These illustrative embodiments are mentioned not to limit or define the invention, but to provide examples to aid understanding thereof. Illustrative embodiments are discussed in the Detailed Description, and further description of the invention is provided there. Advantages offered by various embodiments of this invention may be further understood by examining this specification.

### BRIEF DESCRIPTION OF THE DRAWINGS

These and other features, aspects, and advantages of the present invention are better understood when the following Detailed Description is read with reference to the accompanying drawings, wherein:

FIG. 1 is a block diagram showing an ACP system providing event logging in one embodiment of the present invention;

FIG. 2 is a block diagram showing the one or more components that may be included within the sub-systems of the ACP system in one embodiment of the present invention;

FIG. 3 is a flowchart illustrating a method for event logging in one embodiment of the present invention;

FIG. 4 is a flowchart illustrating a method for event logging in one embodiment of the present invention;

FIG. 5 is a flowchart illustrating a method for event logging in one embodiment of the present invention;

FIG. 6 is a block diagram illustrating a system for event logging in one embodiment of the present invention;

FIG. 7 is a flowchart illustrating a method for logging output signals in an HMI in one embodiment of the present invention;

FIG. 8 is a block diagram illustrating a system for sequence of event recording in one embodiment of the present invention;

FIG. 9 is an illustration of an embodiment of the invention in which there is an angle of incidence between a sensing device and the direction of travel of a vehicle traveling on a roadway past the sensing device;

FIG. 10 is a flowchart illustrating a method for determining a speed of a vehicle in one embodiment of the present invention; and

FIG. 11 is a block diagram illustrating a system for determining a speed of a vehicle in one embodiment of the present invention.

### DETAILED DESCRIPTION

Embodiments of this invention provide systems and methods for event detection and logging in access control points.

Illustration of an Access Control Point System

An access control point (“ACP” or “ACP system”) may be used to control access to areas that are subject to access restrictions. ACP systems may be highly complex systems with a multitude of detection, logging, and response capabilities. For example, in one embodiment, an ACP system is used to control access to a military base and is equipped with sophisticated sensors for detecting approaching people or vehicles, a guardhouse configured with computer monitoring systems, access gates or ports, and emergency systems designed to stop intruders attempting to gain unauthorized access to the restricted area.

For example, the ACP system of such an embodiment may control an access road leading to a restricted area. At the guardhouse, the guard on duty has a human-machine interface (HMI) that provides status information and information about traffic approaching the guardhouse. The guard also has the ability to control a gate that can be raised or lowered across the access road to prevent cars from entering the restricted area. To handle emergency situations, the guardhouse is also equipped with buttons or triggers that generate an alarm and notify military police, if pressed. In addition, the guard is able to activate a barricade capable of deploying in the access road such that the barricade will stop a vehicle attempting to break through the access gate at a high rate of speed.

The ACP system providing access control to the military base is also equipped with an event logging system for storing events detected by the ACP system as well as the times when the events occurred. In the ACP system, the military may want, or require, that logged events be stored with accurate associated timestamps. To provide accurate timestamps, the ACP system includes a global positioning system (GPS) receiver that is used as an accurate time reference, on whose time all timestamps are based. The ACP system also corrects for any communications latency when calculating timestamps to ensure accuracy.

In addition to accurate timestamping, the ACP system also has an event logging system that not only logs events detected by the system, but also commands provided to the system, for example, through the HMI. Logging events provided through the HMI allows the sequence of events detected by the ACP system to be logged sequentially with commands given to the ACP system, painting a complete picture of any situations that may arise.

Also, the ACP system of such an embodiment is able to detect the speed of multiple lanes of approaching vehicles using a single radar sensing device. In such an embodiment, the radar sensing device is positioned such that cars traveling on the access road do not travel directly at the sensing device, which is placed along the side of the access road, but rather approach the device at an angle that takes the cars past the sensing device. The ACP system, using the sensing device, is capable of accurately detecting the speed of vehicles traveling along the access road despite the angled path taken by the vehicles relative to the radar-sensing device.

This example is given to introduce the reader to the general subject matter discussed herein. The invention is not limited to this example. The following sections describe various embodiments of ACP systems and methods for providing event detection and logging.

### Event Logging

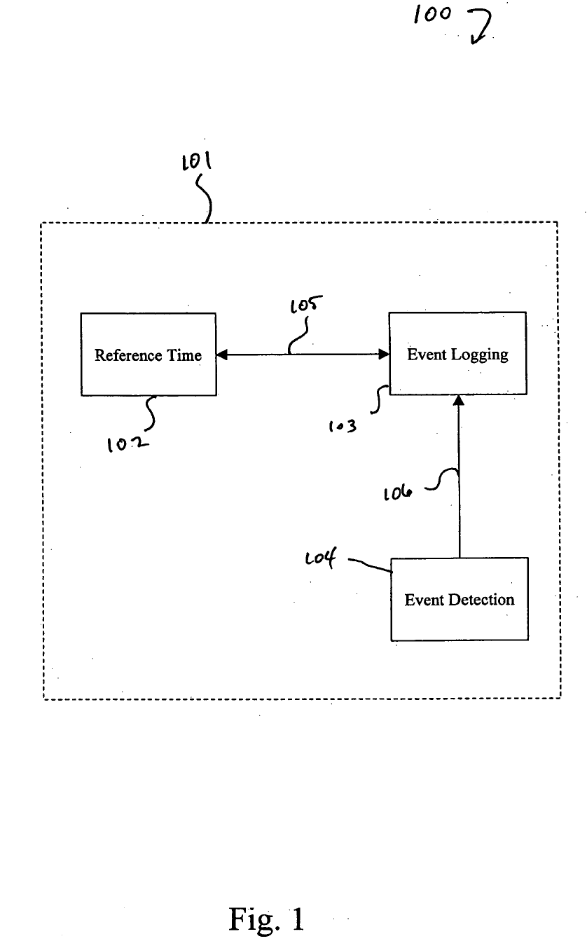

FIG. 1 is a block diagram 100 showing an ACP system 101 providing event logging in one embodiment of the present invention. In the embodiment shown, the ACP system 101 comprises several sub-systems, represented by blocks in the diagram. s. An ACP system 101 as described in this illustrative embodiment comprises a reference time sub-system 102, an event logging sub-system 103, and an event detection sub-system 104. Each sub-system 102, 103, 104 may comprise one or more components that function independently or cooperatively to perform the function of the sub-system 102, 103, 104. Each sub-system 102, 103, 104 may be in communication with other sub-systems 102, 103, 104. For example, in the embodiment shown, the event logging sub-systems 103 may be in communication with the reference time sub-system 102 via communications link 105, and the event detection sub-system 104 via communications link 106. In other embodiments, the ACP system 101 may include additional sub-systems, including, but not limited to, event triggering sub-systems for operating doors or alarms, or recording sub-systems such as cameras or microphones. Further, these sub-systems may be in communication with other sub-systems via communications links.

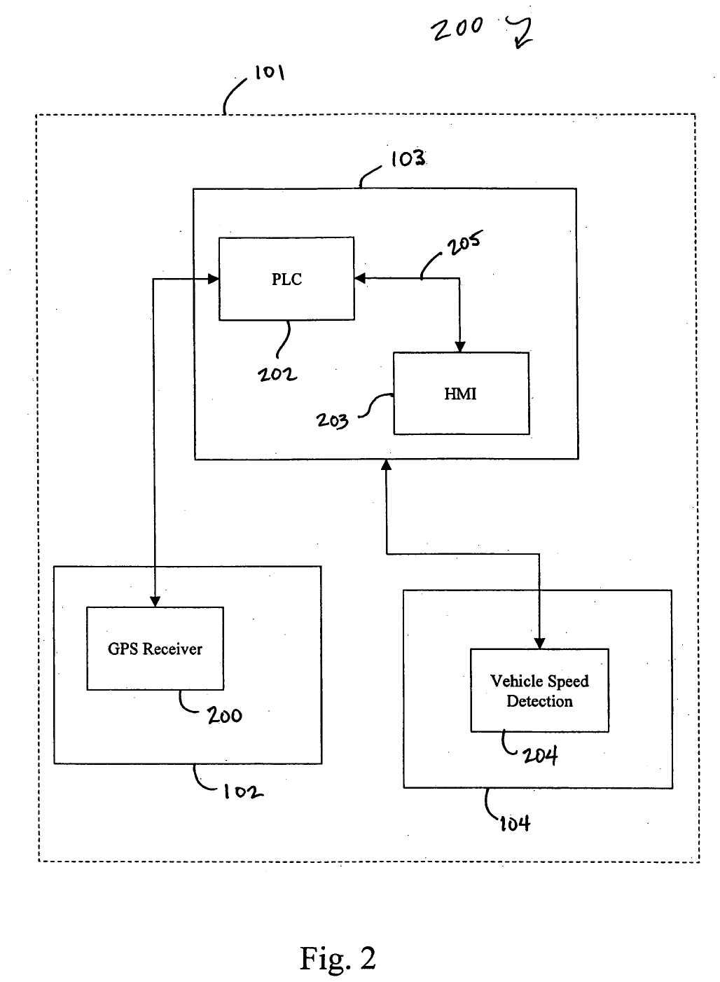

FIG. 2 is a block diagram showing the one or more components that may be included within the sub-systems 102, 103, 104 of the ACP system 101 in one embodiment of the present invention. In the embodiment shown, the reference time sub-system 102 comprises a GPS receiver 201. In other embodiment shown, the reference time sub-system 102 may comprise other time sources including, but not limited to, a personal computer, a server, or a receiver capable of receiving time signals from a remote source.

Still referring to FIG. 2, the embodiment comprises components of the event logging sub-system 103. In the illustrated embodiment, the event logging sub-system comprises a programmable logic controller (PLC) 202 and a HMI 203. In other embodiments of the present invention, the event logging sub-system may comprise a personal computer. A further embodiment of the event logging sub-system may comprise only an HMI 203. In yet a further embodiment, the event logging sub-system may comprise only a PLC 202.

HMI is a generic term for a device that allows a user to interact with a system. An HMI may comprise a processor, a display screen, and an input device. The processor comprises a computer-readable medium, such as a random access memory (RAM) (not shown) coupled to the processor. The processor executes computer-executable program instructions stored in memory, such as executing one or more computer programs for event detection or event logging. Such processors may comprise a microprocessor, an ASIC, and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors comprise, or may be in communication with, media, for example computer-readable media, which stores instructions that, when executed by the processor, cause the processor to perform the steps described herein. Embodiments of computer-readable media include, but are not limited to, an electronic, optical, magnetic, or other storage or transmission device capable of providing a processor, such as the processor 110, with computer-readable instructions. Other examples of suitable media include, but are not limited to, a floppy disk, CD-ROM, DVD, magnetic disk, memory chip, ROM, RAM, an ASIC, a configured processor, all optical media, all magnetic tape or other magnetic media, or any other suitable medium from which a computer processor can read instructions. Also, various other forms of computer-readable media may transmit or carry instructions to a computer, including a router, private or public network, or other transmission device or channel, both wired and wireless. The instructions may comprise code from any suitable computer-programming language, including, for example, C, C++, C#, Visual Basic, Java, Python, Perl, and JavaScript.

A processor within an HMI may be capable of performing a variety of functions including, but not limited to, event logging functions, timing functions, and event detection functions. A user may read information from the HMI's display screens and enter commands with the input device to affect the operation of a system connected to the HMI. Other embodiments of an HMI may include means for communicating with other devices or systems; devices for providing visual or auditory alerts, such as lights or sirens; or communication devices, including but not limited to, a telephone or a radio transceiver.

PLC is a term for a programmable electronic device that may be used to control or interact with portions of an electronic or electromechanical system. A PLC may be a processor as defined above, or other similar device. In some embodiments, a PLC may be configured to communicate with other processors or devices including, but not limited to, HMIs, computers, or servers. In other embodiments, a PLC may be configured to operate as a stand-alone processor in communication with devices configured to be controlled by the PLC including, but not limited to, sensors, motors, or alarms.

It may be advantageous to use an HMI 203 as shown in FIG. 2 as a part of the event logging sub-system for reasons including, but not limited to, an HMI may provide a centralized point to which substantially all detected events may be routed; an HMI may be in communication with substantially all of the sub-systems of an ACP system and may readily issue commands and receive events from such sub-systems; and an HMI may be in communication with a device capable of storing an event log.

The embodiment shown in FIG. 2 further comprises an event detection system 104. In the embodiment shown, the event detection system 104 comprises a vehicle speed detection system 204. Other embodiments of an ACP system 101 may comprise other systems capable of detecting events, including but not limited to button pushes, switch throws, access card swipes, pressure, heat, sound or video.

The embodiment shown in FIG. 2 further comprises communications links 105, 106, 205 over which sub-systems and components of the ACP system 101 are in communication. One of ordinary skill in the art would immediately recognize a large number of communications links that could be used to provide communications links 105, 106, 205. Examples of such communications links include but are not limited to Ethernet; synchronous or asynchronous serial communications links such as RS-232 or RS-422; parallel communications links; wireless connections (including but not limited to IEEE 802.11); FireWire; USB or others that would be apparent to one of ordinary skill in the art. Communications links may also comprise system buses such as ISA, EISA, PCI, VME, or others that would be apparent to one of ordinary skill in the art.

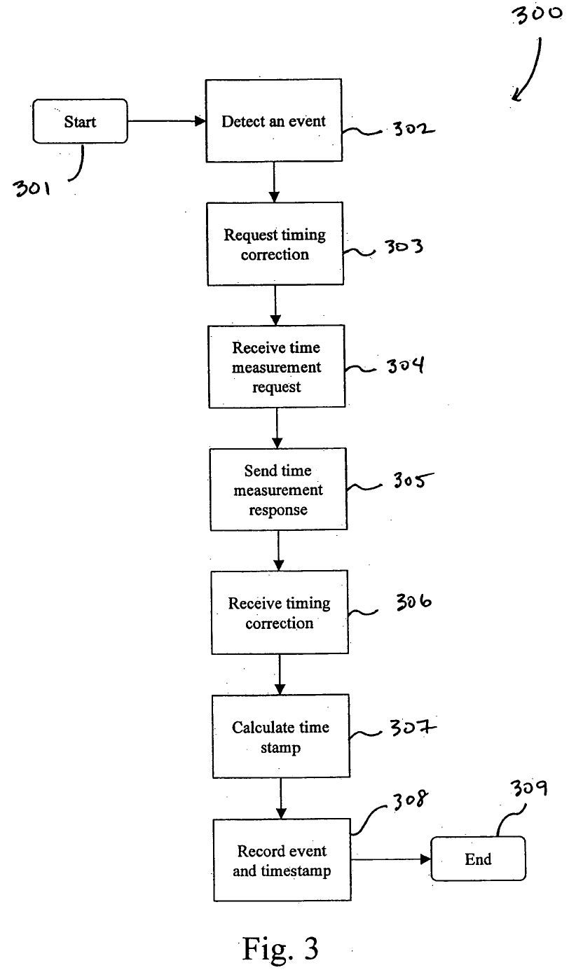

FIG. 3 is a flowchart 300 illustrating a method for event logging in one embodiment of the present invention. The method begins at block 301 and finishes at block 309. In the embodiment shown, the ACP system 101 detects an event 302. In one embodiment, event detection may occur in an HMI 203. In another embodiment, event detection may occur in a sub-system of the ACP system 101 remote from an HMI 203, for example a PLC 202 located in another sub-system of the ACP system 101. In a further embodiment, event detection may be performed by a user interacting with a sub-system of the ACP system 101 who manually enters the detected event.

Once an event has been detected, in the embodiment pictured in FIG. 3, the event logging sub-system 103 transmits a timing correction request over a communications link 303. In the embodiment shown in FIG. 3, the event logging sub-system 103 transmits the timing correction request 303 to a reference time sub-system 102. In another embodiment, the timing correction request 303 might be sent to another sub-system of the ACP system 101 with an internal clock.

After transmitting the timing correction request 303, the event logging sub-system 103 receives a first timing signal 304. In the embodiment shown, the first timing signal contains a first send time. In the embodiment shown, the first send time may be the time given by the clock internal to the sub-system transmitting the time measurement request.

In the embodiment shown in FIG. 3, after the HMI receives the first timing signal 304, it transmits a second timing signal 305. In the embodiment shown, the second timing signal is transmitted to reference time sub-system 102. The second timing signal comprises a second send time, a first receive time associated with the first send time, and the first send time. In the embodiment shown, the first send time contained in the time measurement request 304 may be the same first send time that was received in the time measurement request 304. The first receive time may be the time the event logging sub-system 103 received the time measurement request. The second send time may be the time the second timing signal was transmitted

After transmitting a second timing signal 305, the event logging sub-system 103 receives a timing correction 306. In the embodiment shown in FIG. 3, the timing correction may be based at least in part on a reference time and a latency of the communications link between the event logging sub-system 103 and the reference time sub-system 102. In other embodiments, the timing correction may be based on other variables or constants, such as processing delays of the event logging sub-system 103, the reference time sub-system 102, or both; network usage; user or operator delay; or other factors that may affect timing of the event logging system.

After receiving the timing correction 306, the event logging sub-system 103 determines a corrected timestamp using the timing correction 307. In one embodiment, the timing correction might be a correction factor to be applied to the internal clock of the event logging sub-system of the ACP system 101. In another embodiment, the timing correction might be a new time to which the internal clock of the event logging sub-system of the ACP system may be reset to.

Once the event logging sub-system 103 has calculated the timestamp 307, the event and the corrected timestamp may be recorded in a log 308. Such a log may comprise one or more events and timestamps associated with the events. In one embodiment, the recorded events and associated timestamps may be stored in a non-volatile storage medium such as a computer hard drive, a flash memory chip, an optical drive such as a CD-ROM. In other embodiments, the recorded events may be stored in a volatile storage medium such as random access memory contained within the event logging sub-system of the ACP system. In further embodiments, the log may have a fixed length, such that after a specified number of events have been recorded, new events begin to replace older events already stored in the log. In even further embodiments, the log may have no fixed length and may store as many events as the embodiment's storage medium will allow.

It may be advantageous to use an embodiment of the invention similar to the embodiment shown in FIG. 3 for providing accurate timing for the event logging sub-system 103. If an accurate timing mechanism is incorporated into an ACP system 101, the event logging sub-system 103 may be capable of properly recording the time of events that occur very near to each other in time. For example, if a timing system with an accurate resolution of about 10 milliseconds (ms) is used, the event logging function would be capable of recording events in the correct sequence if two events occur within about 10 ms or more of each other. In other embodiments, the ACP system 101 may be capable of an accurate timing resolution of less than 10 milliseconds. In still other embodiments, the ACP system 101 may be capable of an accurate timing resolution of more than 10 milliseconds.

A further advantage of such an accurate timing system might be to ensure that events requiring very high speed responses are capable of performing the response within the time required. For example, if a response to an event must be performed within 2 seconds of the occurrence of the event, an accurate timing system may provide information relating not only to whether the response occurred within the required time window, but also whether there is a margin for error in the system and how long that margin for error is. For example, if an ACP system 101 must respond to an event within 2 seconds, it may be advantageous to determine that the ACP system 101 may actually be capable of responding to an event within 1.9 seconds. Such information could be used, for example, to increase the speed of the response to critical events or to prioritize responses to events based on the speed at which an ACP system 101 is capable of responding to the events.

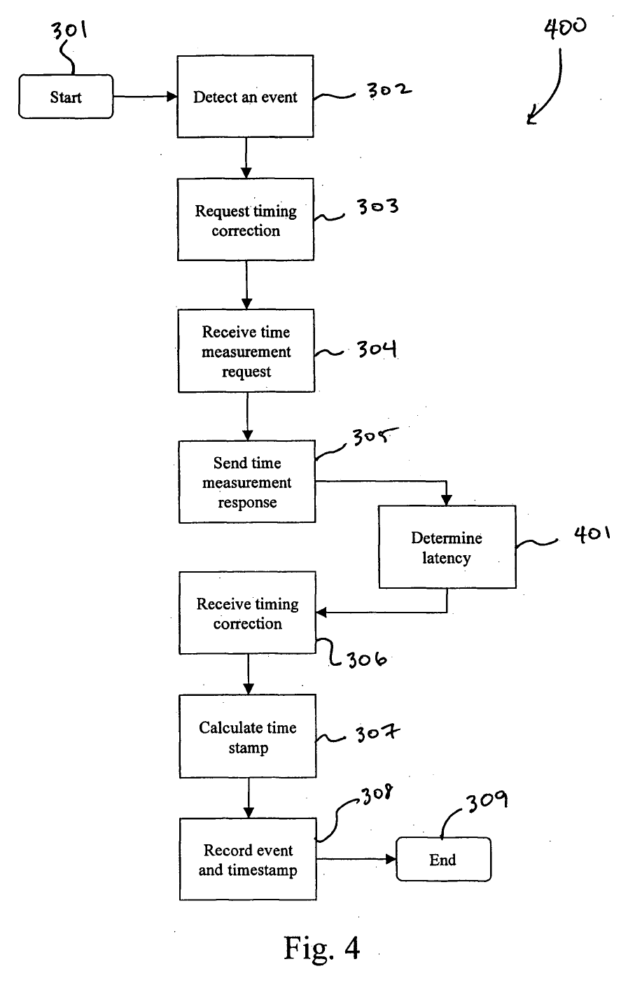

FIG. 4 is a flowchart 400 illustrating a method for event logging in one embodiment of the present invention. The method depicted in FIG. 4 begins at block 301, ends at 309, and is similar to the method depicted in FIG. 3, however, an additional step is performed after the second timing signal is sent 305. After transmitting the second timing signal 305, the embodiment of the invention depicted in FIG. 4 determines the latency of the communications link 401 between the event logging sub-system 103 and the reference time sub-system 102. A latency of the communications link is calculated 401 using information transmitted within the second timing signal 305. Such information may include a first send time, a first receive time associated with the first send time, and a second send time, as described above. In addition, a second receive time associated with a second send time may be used to determine the latency. In an embodiment, a latency of the communications network may be determined 401 by the following steps: (1) subtracting the first send time from the first receive time to calculate a first latency; (2) subtracting the second send time from the second receive time to calculate a second latency; (3) calculating an arithmetic mean of the first latency and the second latency.

In another embodiment, a latency of the communications network may be determined 401 by only subtracting the first send time from the first receive time. In a further embodiment, a latency of the communications network may be determined 401 by only subtracting the second send time from the second receive time. Further embodiments may include additional signals comprising additional send times and receive times associated with the send times. Such embodiments may determine a network latency 401 by performing additional subtractions of send times from the associated receive times and further taking an arithmetic mean of all results of such subtractions.

It may be advantageous in one embodiment of the present invention to correct for communications latency between an event logging sub-system 103 and a reference time sub-system 102. Communications latency between the reference time sub-system 102 and the event logging sub-system 103 may introduce errors into a timing correction transmitted by the reference time sub-system 102. For example, if the reference time sub-system 102 transmits timing correction A to the event logging sub-system 103 and there is a communications latency of about B, the timing correction A may be inaccurate by about B. In an embodiment of the invention where timing may need to be accurate within a time smaller than about B, communications latency may create unacceptable timing inaccuracies in the event logging sub-system 103. Therefore, this invention may be advantageously implemented with a method for determining communications latency 401 between the reference time sub-system of the ACP system 101 and the event logging sub-system 103 and with a method for transmitting timing corrections that are based at least in part on a communications latency between a reference time sub-system 102 and an event logging sub-system 103.

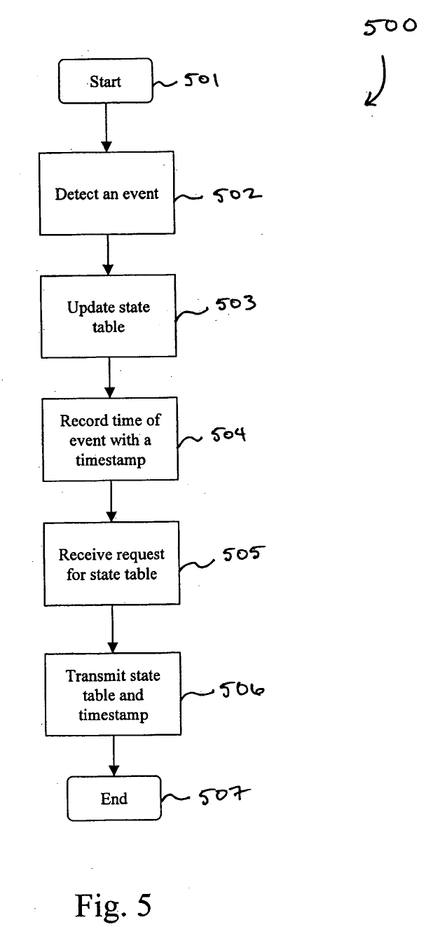

FIG. 5 is a flowchart 500 illustrating a method for event logging in one embodiment of the present invention. The method begins in block 501 and ends at block 507. In the embodiment shown, the ACP system 101 detects an event 502. In one embodiment, event detection may occur in an HMI 203. In another embodiment, event detection may occur in a sub-system of the ACP system 101 remote from an HMI 203, for example a PLC 202 located in another sub-system of the ACP system 101. In a further embodiment, event detection may be performed by a user interacting with a sub-system of the ACP system 101 who manually enters the detected event.

In the embodiment shown in FIG. 5, after an event is detected 502, a sub-system of the ACP system 101 may update a state table based at least in part on the detected event 503. As would be understood by one of ordinary skill in the art, a state table is a data structure comprising one or more entries that is maintained to record the operating states of devices and systems. For example, a state table may include an entry for recording the position of an access door, where a state table value of 0 associated with the access door indicates that the access door is closed, and a state table value of 1 associated with the access door indicates that the access door is opened. In the example just described, an event may indicate a state change in the access door from closed to open. In such an example, the state table would be updated 503 by changing the 0 associated with the position of the access door, indicating the access door as closed, to a 1, indicating the access door is open. The preceding example of a state table is meant to be exemplary and other embodiments of a state table would be readily apparent to one of ordinary skill in the art.

In the illustrated embodiment, the state table described has timestamps associated with state table records. In such an embodiment, when the state table is updated 503, a timestamp is associated with the receipt of the event signal 504. In some embodiments, the timestamp may be stored within the state table in such a way that the timestamp is associated with the recorded event. In other embodiments, the timestamp may be stored separately from the state table such that the recorded timestamp is associated with the recorded event.

Still referring to FIG. 5, the embodiment receives a request for the state table 505. Such a request for the state table 505 may be sent by another sub-system of the ACP system 101. For example, an HMI 203 may send a request for the state table 505 to a PLC 202 which maintains the state table. In another embodiment, a request for the state table 505 may be generated by the sub-system responsible for maintaining the state table. For example, in an embodiment, a sub-system may comprise multiple software tasks executing on a single processor. In the embodiment, a first task may maintain a state table and a second task may be capable of sending a signal to the first task to request the state table, to which the first task will send a signal comprising the state table to the second task.

After receiving a request for the state table 505, the embodiment transmits the state table and associated timestamps 506. In one embodiment, such a response 506 may be transmitted to a remote sub-system of the ACP system 101. In another embodiment, such a response 506 may be sent from a first software task running on a processor to a second software task running on the same processor. In some embodiments, the response to the request 506 may be used by the ACP system 101 for recording in an event log. In some embodiments, the response to the request 506 may be used by the ACP system 101 for updating an HMI 203.

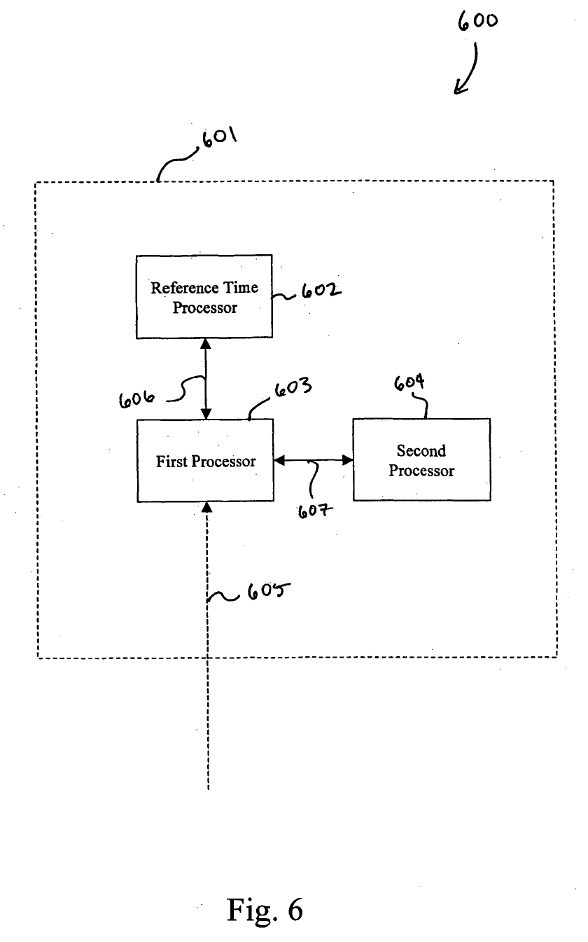

FIG. 6 is a block diagram 600 illustrating a system for event logging in one embodiment of the present invention. In the embodiment shown, the event logging system 601 comprises a first processor 603, a second processor 604, a reference time processor 602, a communications link for the first processor to receive event signals 605, a communications link for the first processor to receive timing signals from the reference time processor 606, and a communications link between the first and second processor for requesting and receiving at least a portion of the state table from the first processor 607. In one illustrative embodiment, the first processor 603 comprises a PLC, the second processor 604 comprises an HMI, and the reference time processor 602 comprises a GPS receiver.

In the depicted embodiment, the first processor 603 is configured to receive an event signal comprising an event identifier, receive a timing signal from a reference time processor 602, and store the event identifier and a time stamp in a state table. In other embodiments, the first processor may comprise additional configurations, including but not limited to configurations to receive requests for timing corrections, to send requests for timing measurements, or to calculate a latency of a communications link. In some embodiments, the first processor 603 may be a PLC, an HMI, a personal computer, or a server. One of ordinary skill in the art would be familiar with other embodiments not listed here, but capable of insertion into the system as a first processor 603.

Still referring to FIG. 6, the second processor 604 is configured to request at least a portion of the state table comprising an event identifier and a timestamp from the first processor 603, and receive the at least a portion of the state table from the first processor 603, and to store the at least a portion of the state table. In other embodiments, the second processor 604 may be configured to do any of, but not limited to, the following: request timing corrections, respond to timing measurement requests, or generate events. In some embodiments, the second processor 604 may be an HMI, a PLC, a personal computer, or a server.

### Sequence of Events Recording

In one illustrative embodiment of the present invention, an ACP system may comprise an HMI for a user to control various actions and responses of the ACP system. As described above, event logging and recording a sequence of events may be a desirable property of an ACP system. In addition, it may be more desirable to record not only the event detected by the various sensors within the ACP system, but also input made by an individual using an HMI incorporated within the ACP system. Recording events detected both by the ACP system as well as signals sent to the ACP system by an HMI can be advantageous in evaluating the effectiveness of the ACP systems response to detected events, the effectiveness of alerts designed to gain the attention of a user of the ACP system, and the response speed of a user of the ACP system to a particular event.

For example, in an ACP system controlling access to a military base, the user may be required to respond to an emergency event, such as a vehicle traveling at a high rate of speed towards the ACP system, within a few seconds. If the event logging sub-system of the ACP system is capable of logging user commands sent by the HMI, it may be possible to examine the event log after an emergency event to determine whether the user responded appropriately and within time to prevent any unauthorized access. Or, alternatively, the desired response time to a particular event may be unknown and, by examining event logs, it may be possible to identify the average response times to particular events and use that information to develop improved procedures for reacting to various events.

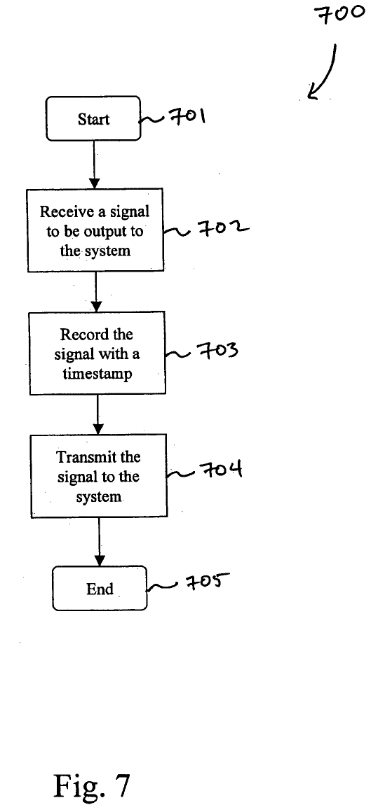

FIG. 7 is a flowchart 700 illustrating a method for logging output signals in an HMI in one embodiment of the present invention. The method begins at block 701 and ends at block 705. A processor within the event logging sub-system 103 will receive an output signal from the HMI 702. In one embodiment, the signal sent to the system may be generated manually by a user issuing a command from the HMI. In another embodiment, the signal may be automatically generated by the HMI. For example, the HMI may periodically generate a signal to the system without intervention by a user. In another embodiment, the HMI may generate a signal to the system in response to an event occurring in the ACP system 101 without requesting intervention by a user.

After receiving the output signal 702, the processor will record the output signal with a timestamp in an event log 703. In one embodiment, the timestamp may be calculated as described above using a reference time processor. In other embodiments, the timestamp may be generated by the processor responsible for recording the signal in the event log 703.

After recording the signal with the timestamp in the event log 703, the processor may transmit the output signal over a communications link 704. However, the order of steps 703 and 704 may be different. In other embodiments, the signal may be transmitted 704 to the system before recording the signal and associated timestamp 703 in the event log. In still other embodiments, the order in which the signal is recorded 703 and transmitted 704 to the system may not be fixed. For example, in one embodiment, two separate software tasks may be executing on a processor. A first software task may be responsible for recording signals from an HMI to an event log 703 and a second software task may be responsible for transmitting signals from an HMI to the ACP system 704. In such an embodiment, the order in which the steps occur may depend on the relative priorities of the software tasks within the processor. In a different embodiment, the order in which the steps occur may depend on communication constraints.

In one illustrative embodiment of the present invention, it may be advantageous to incorporate the method depicted in FIG. 7 for logging output signals. Output signals to control the system may cause additional events to be detected within the system. For example, an output signal may cause an access gate or door to open. Such an action may cause a “door open” or “gate open” event to be detected. It may also cause even more additional events to be detected. For example, a door or gate that had been opened may then close, causing a door close or gate close event to be detected. If one embodiment of the present invention incorporating a method similar to the method depicted in FIG. 7 detects output signals, it may generate sequence of event logs that are more advantageously used to perform actions including, but not limited to, modifying response sequences to detected events, automate response sequences to detected events, or streamline procedures for responding to detected events.

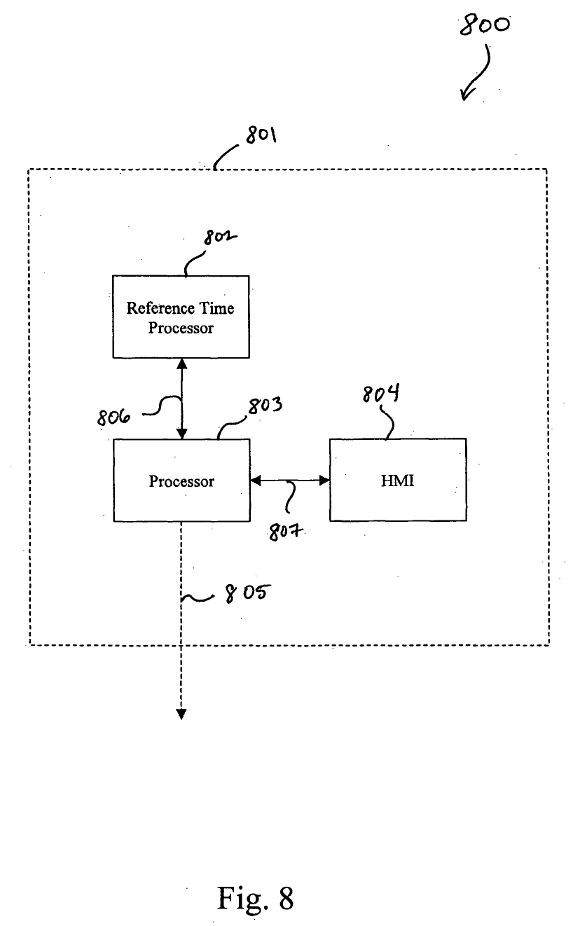

FIG. 8 is a block diagram 800 illustrating a system for sequence of event recording 801 in one embodiment of the present invention. The embodiment 800 comprises a reference time processor 802, a processor 803, an HMI 804, a communications link 805 for transmitting signals to the ACP system 101, a communications link 806 to allow communications between the reference time processor 802 and the processor 803, and a communications link 807 to allow communications between the HMI 804 and the processor 803.

Still referring to FIG. 8, reference time processor 802 may comprise one or more processors capable of providing timing information including, but not limited to, a timestamp, a timing correction, or a communications latency to the processor 803. For example, one embodiment of the reference time processor 802 may comprise a GPS receiver and a PLC, where the PLC and the GPS receiver are in communication with each other and the processor 803. In one embodiment, the PLC may be capable of responding to timing correction requests as described above. In another embodiment, the PLC may be capable of responding to a request for a timestamp. In a further embodiment, the reference time processor 802 may comprise only a GPS receiver in communication with the processor 803, the GPS receiver capable of providing timing information to the processor 803 over communications link 806.

The embodiment shown in FIG. 8 further comprises a processor 803. Processor 803 is configured to receive output signals from an HMI 804, receive timing information from the reference time processor 802, store the output signals and a timestamp, and transmit the output signal over a communications link 805. In further embodiments, processor 803 may comprise one or more processors. In an embodiment comprising multiple processors, each processor may be in communication with each other in order to communicate with the reference time processor 802 and the HMI 804, to record signals from the HMI 804, and to transmit signals over communications link 805.

HMI 804 is in communication with processor 803 and may be capable of sending signals to processor 803. As described above, an HMI 804 comprises processors and screens manipulatable by a user for sending output signals to the ACP system. An HMI 804 may further be capable of sending output signals to the ACP system without user intervention.

### Speed Detection

In an ACP system, it may be desirable to measure the speed and direction of vehicles in proximity to the ACP system. In a conventional ACP system, a speed-sensing system that monitors the speed and direction of multiple lanes of traffic may measure speed and direction of the lanes of traffic using one sensing device per lane of traffic. In such a configuration, each sensing device is positioned such that the lane of traffic that it monitors travels substantially directly at the sensing device. Such a configuration is used because sensing devices using radar signals to measure speed are subject to increasingly greater error in measurement the greater the angle between the path of the oncoming traffic and the direction of the radar signals transmitted from the sensing device. This phenomenon is well known in the art as the cosine effect.

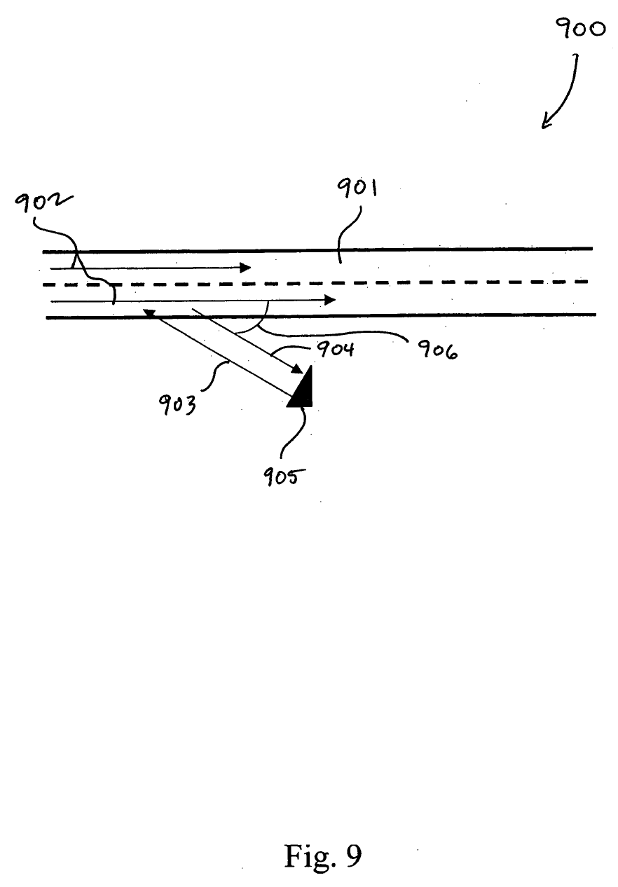

FIG. 9 is a depiction of an embodiment of the invention in which there is an angle of incidence 906 between a sensing device 905 and the direction of travel of a vehicle 902 traveling on a roadway 901 past the sensing device 905. As the angle of incidence 906 between the direction of a moving vehicle 902 and the path of the reflected radar signal 904 increases, the detected speed of the vehicle is only a percentage, less than 100%, of the actual speed of the vehicle. The rate of error of such a measurement is about equal to the cosine of the angle of incidence 906. For example, at an angle of incidence 906 of about 30 degrees between the sensing device 905 and the direction of a moving vehicle 902, the sensing device 905 will only report a vehicle speed of about 86.6% of the true speed of the vehicle. If the angle of incidence 906 is ninety degrees, meaning the direction of the moving vehicle 902 is perpendicular to the path of the transmitted radar signals 903 and reflected radar signals 904 from the sensing device 905, the sensing device 905 will report a speed of 0 regardless of the true speed of the vehicle. As such, a problem to be solved in using a single sensing device 905 to detect the speed of a vehicle is how to correct for error created by positioning a sensing device 905 such that the vehicle may be traveling at an angle of incidence 906 to the path of the transmitted and reflected radar signals 903, 904 that may cause error in the reported speed of the vehicle.

To solve this problem, the present invention includes a method and system for determining the angle-based error and correcting the speed measurement based at least upon that angle-based error.

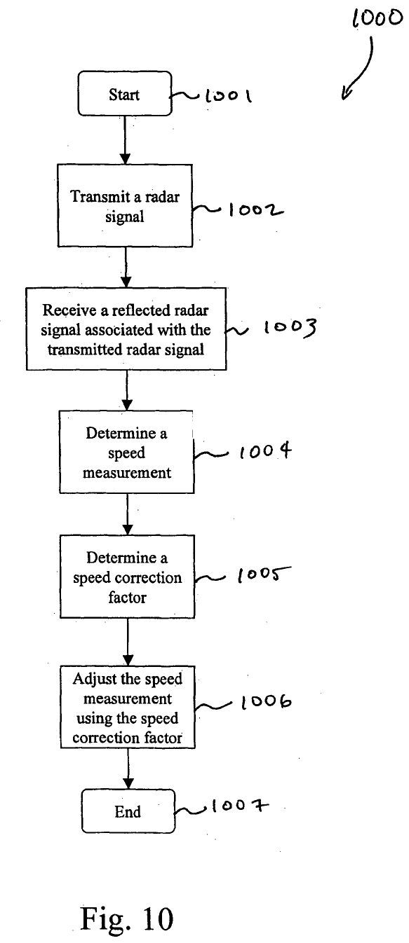

FIG. 10 is a flowchart 1000 illustrating a method for determining a speed of a vehicle in one embodiment of the present invention. The method begins at step 1001 and ends at step 1007. The speed-sensing system transmits a radar signal 1002. In one embodiment, the radar signal may be focused into a narrow beam. In another embodiment, the radar signal may be focused in to a wide beam.

After transmitting a radar signal 1002, the speed-sensing system receives a reflected radar signal 1003 associated with the transmitted radar signal. In an embodiment, the received radar signal may have an angle of incidence of greater than about 0 degrees and less than about 90 degrees to the flow of traffic.

After receiving the reflected radar signal 1003 associated with the transmitted radar signal, the speed-sensing system determines a speed measurement 1004 based at least in part on the reflected radar signal. In an embodiment, the speed measurement may have an associated error based at least in part on the angle of incidence.

The speed-sensing system may determine a speed correction factor 1005 based at least in part on the angle of incidence. In another embodiment, the speed-sensing system may determine a speed correction factor based on the angle of incidence and a speed measurement. The speed-sensing system may adjusts the speed measurement using the speed correction factor 1006.

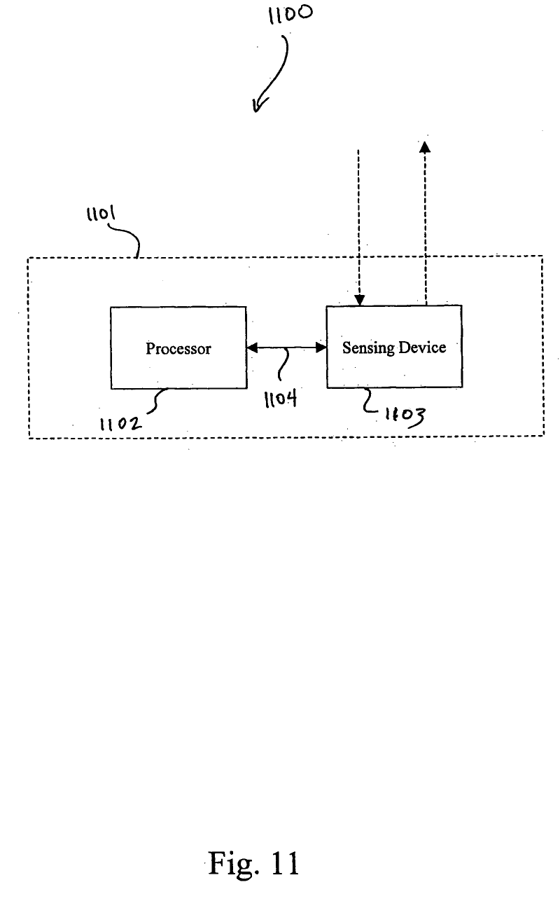

FIG. 11 is a block diagram 1100 illustrating a system for determining a speed of a vehicle 1101 in one embodiment of the present invention. The system 1101 comprises a processor 1102, a single sensing device 1103, a communications link 1104 enabling communication between the processor 1102 and the sensing device 1103. Other embodiments of a system for detecting a speed of a vehicle 1101 may comprise additional components including, but not limited to, a sensing device for detecting a distance to a vehicle, a communications link from the processor 1102 to an ACP system, or other elements advantageous to a speed-sensing system 1101.

In the embodiment shown in FIG. 11, the processor 1102 element of the speed-sensing system 1101 is configured to determine a speed correction factor based at least in part on an angle of incidence of the reflected radar signal to the direction of travel of a vehicle, and to adjust the speed measurement based at least in part on the angle of incidence. In another embodiment, the processor 1102 may be configured to perform other tasks including, but not limited to, determining a distance to a vehicle, determining the speed of a vehicle, or determining the direction of travel of a vehicle. In one embodiment, the processor 1102 may comprise one or more processors.

The processor 1102 is in communication with a sensing device 1103. In an embodiment, the sensing device 1103 comprises a single sensing device configured to transmit a radar signal, receive a reflected radar signal associated with the transmitted radar signal at an angle of incidence, determine a speed measurement based at least in part on the reflected radar signal, and transmit the speed measurement to the processor. In another embodiment, the sensing device 1103 may comprise two devices, one capable of transmitting radar signals and the other capable of receiving radar signals. In such an embodiment, the two devices may be in communication with each other. In another embodiment, the two devices may be in communication with a third device capable of communicating with the transmitting device and the receiving device and may be further capable of calculating a speed measurement based on transmitted and received radar signals.

### General

The foregoing description of the embodiments, including preferred embodiments, of the invention has been presented only for the purpose of illustration and description and is not intended to be exhaustive or to limit the invention to the precise forms disclosed. Numerous modifications and adaptations thereof will be apparent to those skilled in the art without departing from the spirit and scope of the this invention.

That which is claimed is:

1. A method for event recording comprising:
detecting an event;
transmitting a timing correction request over a communications link;
receiving a first timing signal having a first send time;
transmitting a second timing signal having a second send time, a first receive time associated with the first send time, and the first send time;
receiving a timing correction based at least in part on a reference time and a latency of the communications link;
determining a corrected timestamp using the timing correction; and
recording the event and the corrected timestamp.

2. The method of claim 1 further comprising computing the latency by:
determining a first latency by subtracting the first send time from the first receive time;
determining a second latency by subtracting the second send time from a second receive time associated with the second send time; and
determining an arithmetic mean of the first latency and the second latency.

3. A method for event recording comprising:
detecting an event;
updating a state table based at least in part on the event;
associating a timestamp with the receipt of the event signal;
receiving a request for the state table;
transmitting the state table and the timestamp

4. A system for event recording comprising:
a first processor configured to:
receive an event signal comprising an event identifier,
receive a timing signal from a reference time processor, and
store the event identifier and a timestamp in a state table;
a second processor in communication with the first processor the second processor configured to:
request at least a portion of the state table comprising an event identifier and a timestamp from the first processor,
receive the at least a portion of the state table from the first processor, and to store the at least a portion of the state table.

5. The system of claim 4 where the first processor comprises a programmable logic controller.

6. The system of claim 5 where the second processor comprises a human machine interface.

7. The system of claim 4 where the reference time processor comprises a global positioning system receiver.

8. A method for logging output signals in a human-machine interface comprising:
receiving an output signal from a human-machine interface;
recording the output signal with a timestamp; and
transmitting the output signal over a communications link.

9. A system for logging output signals in a human-machine interface comprising:
a human-machine interface; and
a processor in communication with the human-machine interface, the processor configured to:
receive an output signal from the human-machine interface,
receive timing information from a reference time processor,
store the output signal and a timestamp, and
transmit the output signal over a communications link.

10. The system of claim 9 further comprising an Access Control Point.

11. The system of claim 9 where the reference time processor is a global positioning system receiver.

12. The system of claim 9 further comprising:
a sensing device configured to:
transmit a radar signal,
receive a reflected radar signal associated with the radar signal,
determine a speed measurement based at least in part on the reflected radar signal, and
transmit the speed measurement to the processor; and
a processor in communication with the single sensing device configured to:
determine a speed correction factor based at least in part on an angle of incidence of the reflected radar signal, and
adjust the speed measurement based at least in part on the angle of incidence.

13. A computer-readable medium on which is encoded program code for event recording, the program code comprising:
program code for detecting an event;
program code for transmitting a timing correction request over a communications link;
program code for receiving a first timing signal having a first send time;
program code for transmitting a second timing signal having a second send time, a first receive time associated with the first send time, and the first send time;
program code for receiving a timing correction based at least in part on a reference time and a latency of the communications link;
program code for determining a corrected timestamp using the timing correction; and
program code for recording the event and the corrected timestamp.

14. A computer-readable medium on which is encoded program code for logging output signals in a human-machine interface, the program code comprising:
program code for receiving an output signal from a human-machine interface;
program code for recording the output signal with a timestamp; and
program code for transmitting the output signal over a communications link.
